(19) United States
(12) Patent Application Publication
(10) Pub. No.: US 2014/0330680 A1
(43) Pub. Date: Nov. 6, 2014

(54) E-COMMERCE SYSTEM THAT ALLOWS FOR SELLER RESTRICTIONS BASED ON SOCIAL MEDIA ACCOUNT CHARACTERISTICS

(71) Applicant: International Business Machines Corporation, (US)

(72) Inventors: Divya Gopinath, Clarksburg, MD (US); Rajesh Radhakrishnan, Reston, VA (US); Jennifer A. Watson, Ontario (CA)

(73) Assignee: International Business Machines Corporation, Armonk, NY (US)

(21) Appl. No.: 13/887,284

(22) Filed: May 4, 2013

(51) Int. Cl. G06Q 50/00; G06Q 30/06

(52) U.S. Cl. CPC G06Q 50/01; G06Q 30/0637
USPC 705/26.82

(57) ABSTRACT

A computer receives a first restriction on the sale of an item from a seller, wherein the first restriction is based on at least one social media account characteristic. The computer receives an offer for purchase of the item from a buyer, wherein the offer includes characteristics of a social media account of the buyer. The computer determines whether the characteristics of the social media account of the buyer satisfies the first restriction on the sale of the item. Based on the determination of whether the characteristics of the social media account of the buyer satisfies the first restriction on the sale of the item, the computer determines whether to transmit the offer for purchase of the item to the seller.

### FIELD OF THE INVENTION

The present invention relates generally to e-commerce sales, and more particularly to an e-commerce sales system that allows sellers to place restrictions on items for sale based on social media account characteristics.

### BACKGROUND

The Internet has completely revolutionized the marketplace. Retail stores have decreased their physical presence and instead rely on their online sales to maintain a steady revenue stream. Online marketplaces have become increasingly attractive for small merchants and individuals looking to conduct peer-to-peer transactions as well. Prior to the explosion of online peer-to-peer marketplace websites such as eBay® (eBay is a registered trademark of eBay Corporation); peer-to-peer transactions were performed by way of garage sales, newspaper ads and other archaic means. These forms of peer-to-peer marketplaces limited the exposure of the item for sale to a specific area, such as a neighborhood or a town, and did not take a potential buyer's personal and consumer characteristics into account.

### SUMMARY

Embodiments of the present invention provide a system, method, and program product for an e-commerce sales system that allows sellers to place restrictions on items for sale based on social media account characteristics. A computer receives a first restriction on the sale of an item from a seller, wherein the first restriction is based on at least one social media account characteristic. The computer receives an offer for purchase of the item from a buyer, wherein the offer includes characteristics of a social media account of the buyer. The computer determines whether the characteristics of the social media account of the buyer satisfies the first restriction on the sale of the item. Based on the determination of whether the characteristics of the social media account of the buyer satisfies the first restriction on the sale of the item, the computer determines whether to transmit the offer for purchase of the item to the seller.

### BRIEF DESCRIPTION OF THE SEVERAL VIEWS OF THE DRAWINGS

FIG. 1 illustrates an e-commerce sales system, in accordance with an embodiment of the invention.

FIG. 2 is a flowchart illustrating the operations of the sales program of FIG. 1 in identifying if offers for purchase satisfy restrictions placed on items for sale based on social media account characteristics, in accordance with an embodiment of the invention.

FIG. 3 is a block diagram depicting the hardware components of the e-commerce sales system of FIG. 1, in accordance with an embodiment of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program, for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions, which execute on the computer or other programmable apparatus, provide processes for implementing the functions/acts specified in the flowchart and/or block diagram block or blocks.

Embodiments of the present invention will now be described in detail with reference to the accompanying Figures.

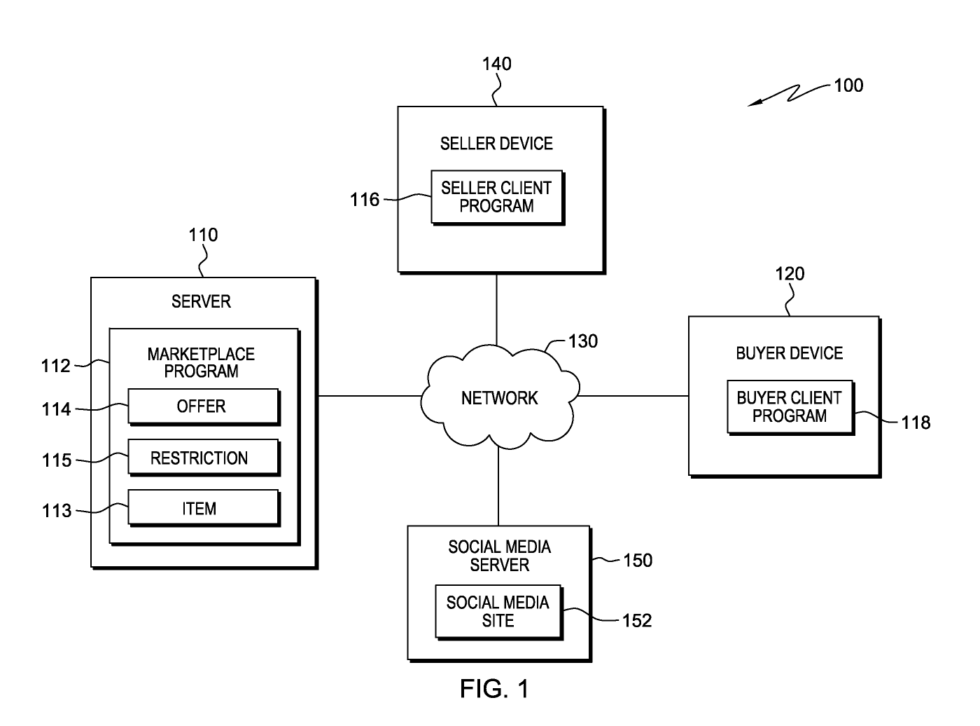

FIG. 1 illustrates e-commerce sales system 100, in accordance with an embodiment of the invention. In an exemplary embodiment, e-commerce sales system 100 includes server 110, buyer device 120, seller device 140, and social media server 150 all interconnected via network 130.

In the exemplary embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between server 110, buyer device 120, seller device 140, and social media server 150.

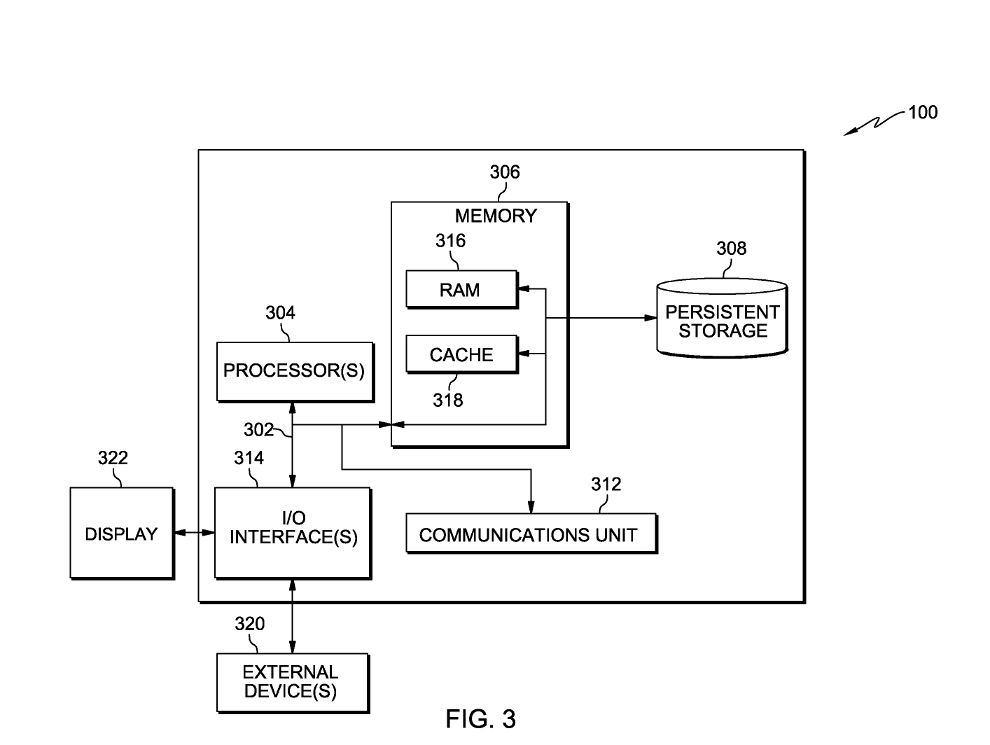

Social media server 150 includes social media site 152. Social media server 150 may be a desktop computer, a notebook, a laptop computer, a tablet computer, a handheld device, a smart-phone, a thin client, or any other electronic device or computing system capable of receiving and sending data to and from other computing devices such as buyer device 120, seller device 140 and server 110 via network 130. Although not shown, optionally, social media server 150 can comprise a cluster of web servers executing the same software to collectively process the requests for the web pages as distributed by a front end server and a load balancer. In an exemplary embodiment, social media server 150 is a computing device that is optimized for the support of websites which reside on social media server 150, such as social media site 152, and for the support of network requests related to websites, which reside on social media server 150. Social media server 150 is described in more detail with reference to FIG. 3.

Social media site 152 is a collection of files including, for example, HTML files, CSS files, image files and JavaScript files. Social media site 152 can also include other resources such as audio files and video files. In an exemplary embodiment, social media site 152 is a social media website such as Facebook® (Facebook is a registered trademark of Facebook, Inc.), Twitter® (Twitter is a registered trademark of Twitter, Inc.), LinkedIn® (LinkedIn is a registered trademark of LinkedIn, Ltd.), or Myspace® (Myspace is a registered trademark of Myspace, LLC).

Server 110 includes marketplace program 112. In the exemplary embodiment, server 110 may be a desktop computer, a notebook, a laptop computer, a tablet computer, a handheld device, a smart-phone, a thin client, or any other electronic device or computing system capable of receiving and sending data to and from other computing devices, such as social media server 150, buyer device 120 and seller device 140, via network 130. While server 110 is shown as a single device, in other embodiments, server 110 may be comprised of a cluster or plurality of computing devices, working together or working separately. Server 110 is described in more detail with reference to FIG. 3.

Marketplace program 112 includes item data 113, offer 114 and restriction 115. In the exemplary embodiment, marketplace program 112 is a website while in other embodiments; marketplace program 112 is a software application capable of functioning as an online marketplace via network 130. Marketplace program 112 is capable of receiving data, such as sales restrictions, descriptions of items for sale from seller device 140, purchase offers from buyer device 120, and characteristics/information of the social media account of the user of seller device 140 (the term social media also includes professional networks) and of the user of buyer device 140 directly from social media server 150 via network 130 or indirectly from seller device 140 or buyer device 120 via network 130 (after social media characteristics have been retrieved by seller device 140 or buyer device 120 from social media server 150). Social media account characteristics can include social media profile information, product or event likes/dislikes, opinions and statements posted on a social media account, location information, information regarding which social media groups a social media user is a member of, or a variety of other information available by accessing the social media account of the user. Marketplace program 112 is also capable of transmitting data to social media server 150, buyer device 120 and seller device 140 via network 130. In addition, marketplace program 112 is capable of determining whether a purchase offer for an item received from buyer device 120 satisfies sales restrictions on the item received from seller device 140.

In the exemplary embodiment, item data 113 is data detailing a specific item for sale received by marketplace program 112 from seller client program 116 via network 130. In the exemplary embodiment, item data 113 also includes social media account characteristics of the user of seller device 140, which are retrieved by seller client program 116 from social media server 150 via network 130.

In the exemplary embodiment, offer 114 is an offer for the purchase of the item described by item data 113 received by marketplace program 112 from buyer device 120 via network 130. In the exemplary embodiment, offer 114 also includes social media account characteristics of the user of buyer device 120, which are retrieved by buyer client program 118 from social media server 150 via network 130. In other embodiments, once marketplace program 112 receives offer 114 from buyer device 120, marketplace program 112 retrieves social media account characteristics of the user of buyer device 120 from social media server 150 via network 130.

In the exemplary embodiment, restriction 115 is a restriction, based on at least one social media characteristic, on the sale of the item described by item data 113, received from seller device 140 via network 130. In the exemplary embodiment, if social media account characteristics are not included in item data 113, social media account characteristics of the user of seller device 140 are included in restriction 115, retrieved by seller client program 116 from social media server 150 via network 130. In other embodiments, restriction 115 may be a plurality of social media restrictions on the sale of the item described by item data 113. In addition, in the exemplary embodiment, restriction 115 may include an expiration date/time for one or more restrictions included in restriction 115, or for restriction 115 as a whole. In other embodiments, the expiration date/time information may be input into seller client program 116 via a user interface by the user of seller device 140. The input expiration date/time information is then transmitted to marketplace program 112 via network 130 and stored in association with restriction 115.

Buyer device 120 includes buyer client program 118. In the exemplary embodiment, buyer device 120 may be a desktop computer, a notebook, a laptop computer, a tablet computer, a handheld device, a smart-phone, a thin client, or any other electronic device or computing system capable of receiving and sending data to and from other computing devices, such as server 110 and seller device 140, via network 130. While buyer device 120 is shown as a single device, in other embodiments, buyer device 120 may be comprised of a cluster or plurality of computing devices, working together or working separately. Buyer device 120 is described in more detail with reference to FIG. 3.

In the exemplary embodiment, buyer client program 118 is a web browser; however, in other embodiments, buyer client program 118 may be a software application capable of receiving input, such as purchase offers, from a user, via a user interface, and transmitting the input to marketplace program 112 via network 130. Buyer client program 118 is also capable of receiving data from marketplace program 112 via network 130 and displaying it to a user via a user interface.

Seller device 140 includes seller client program 116. In the exemplary embodiment, seller device 140 may be a desktop computer, a notebook, a laptop computer, a tablet computer, a handheld device, a smart-phone, a thin client, or any other electronic device or computing system capable of receiving and sending data to and from other computing devices, such as server 110 and buyer device 120, via network 130. While seller device 140 is shown as a single device, in other embodiments, seller device 140 may be comprised of a cluster or plurality of computing devices, working together or working separately. Seller device 140 is described in more detail with reference to FIG. 3.

In the exemplary embodiment, seller client program 116 is a web browser; however, in other embodiments, seller client program 116 is a software application capable of receiving input, such as sales restrictions and information regarding an item for sale, from a user, via a user interface, and transmitting the input to marketplace program 112 via network 130. Seller client program 116 is also capable of receiving data from marketplace program 112 via network 130 and displaying it to a user via a user interface.

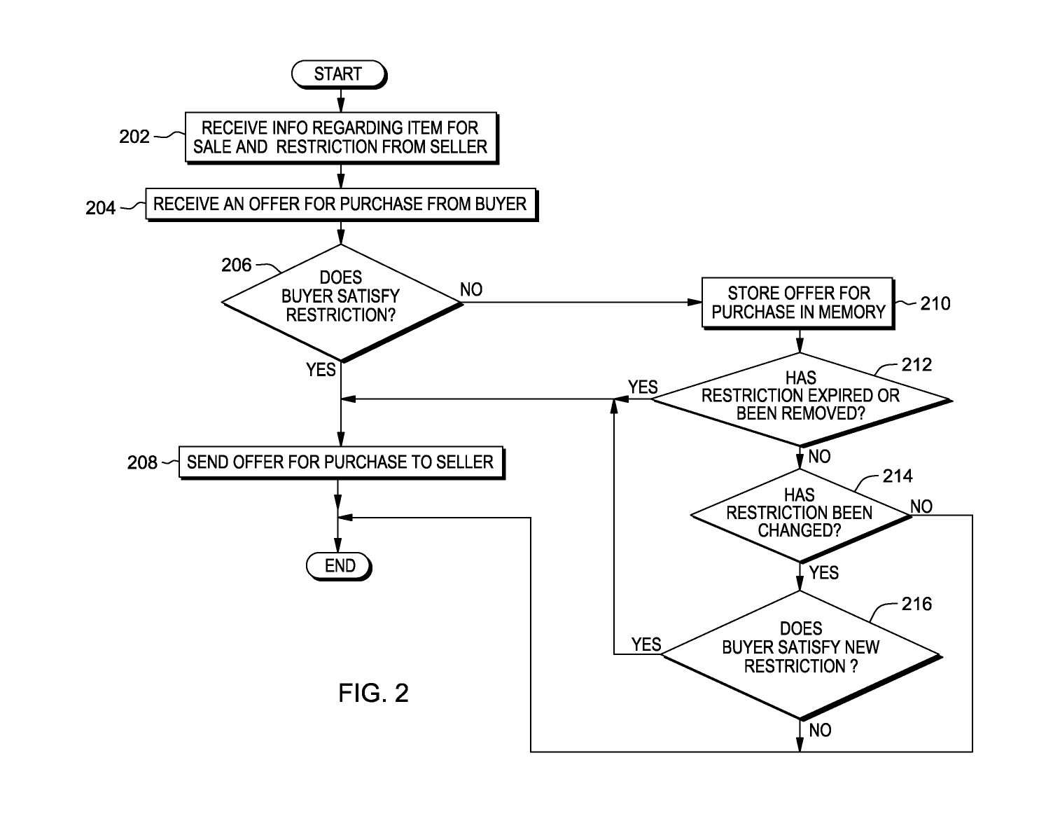

FIG. 2 is a flowchart illustrating the operations of marketplace program 112 in identifying if offers for purchase satisfy sales restrictions placed on items for sale, in accordance with an embodiment of the invention. In the exemplary embodiment, marketplace program 112 receives information regarding an item for sale, i.e., item data 113, and a restriction, based on at least one social media characteristic, associated with the sale of the item described by item data 113, i.e., restriction 115, from seller client program 116 via network 130 (step 202). In the exemplary embodiment, the user of seller device 140 inputs item data 113 and restriction 115 into seller client program 116 via a user interface. Seller client program 116 then transmits item data 113 and restriction 115 to marketplace program 112 via network 130. In the exemplary embodiment, seller client program 116 retrieves social media account characteristics of the user of seller device 140 from social media server 150 and includes the social media account characteristics in item data 113 or restriction 115. Marketplace program 112 then stores restriction 115 in memory in association with item data 113 and places the item described by item data 113 on sale by creating a document, such as a web page, detailing the information contained in item data 113 and making the document available for download by other computing devices via network 130. In the exemplary embodiment, marketplace program 112 only makes the document available for download only to specific buyers or groups based on restriction 115. For example, if restriction 115 states that the item described by item data 113 is to be offered for sale only to members of the social network of the user of seller device 140, marketplace program 112 makes the document detailing the information contained in item data 113 available for download only to members of the social network of the user of seller device 140. In other embodiments, marketplace program 112 may make the document that places the item described by item data 113 on sale available for download to anyone.

In other embodiments, marketplace program 112 may also include the information contained in restriction 115 in the document as well. In addition, in other embodiments, restriction 115 may be input by the user of seller device 140 at a time after item data 113 is input and received by marketplace program 112. In this embodiment, marketplace program 112 would create a document, such as a web page, reciting the information contained in item data 113 and offering the item described by item data 113 for sale by making the document available for download by other computing devices via network 130. However, in this embodiment, no restriction would be associated with item data 113 until restriction 115 is received by marketplace program 112 from seller client program 116.

In further embodiments, restriction 115 may not only restrict the potential buyers to a specific social media group, but also based on interests, “likes/dislikes”, location or other social media information. In this embodiment, marketplace program 112 receives information, such as keywords pertaining to the item described by item data 113, or other keywords as desired by the user of seller device 140, from seller client program 116. For example, the user of seller device 140 may specify an item for sale, a bike, is only to be sold to a certain social media group and in addition, the user of seller device 140 may restrict the sale further by specifying that only buyers who have a certain keyword or a certain keyword out of a set of keywords may purchase the item described by item data 113. Since the item for sale is a bike, the user of seller device 140 may specify that the item is only to be sold to members of the specified social media group whose social media account characteristics contain keywords such as “bike”, “pedal”, “marathon”, and “race”. In this embodiment, the user of seller device 140 inputs the desired keywords into seller client program 116 via a user interface. Seller client program 116 then transmits the keywords as part of restriction 115. In even further embodiments, marketplace program 112 may use word association software to determine keywords related to the item described by item data 113.

Marketplace program 112 then receives an offer, offer 114, for the purchase of the item described by item data 113 from buyer client program 118 via network 130 (step 204). In the exemplary embodiment, the document created by marketplace program 112 that details the information contained in item data 113 is downloaded by buyer client program 118 via network 130 and displayed to the user of buyer device 120 via a user interface. Buyer client program 118 then receives input from the user of buyer device 120, i.e., offer 114, via the user interface and transmits offer 114 to marketplace program 112 via network 130. As stated above, in the exemplary embodiment, buyer client program 118 retrieves social media characteristics of the user of buyer device 120 from a social media server and includes the social media account characteristics in offer 114. In other embodiments, once marketplace program 112 receives offer 114 from buyer device 120, marketplace program 112 retrieves social media account characteristics of the user of buyer device 120 from a social media server.

Marketplace program 112 then determines if the social media account characteristics of the user of buyer device 120 satisfies restriction 115 (decision 206). For example, if restriction 115 states that the item described by item data 113 is only to be sold to a buyer that is a member of a particular social media group, such as members of the social network of the user of seller device 140 that live in the DC area, marketplace program 112 examines the social media account characteristics of the user of buyer device 120 to determine if the user of buyer device 120 is a member of the social network of the user of seller device 140 and lives in the DC area.

As stated above, in other embodiments, restriction 115 may be a plurality of restrictions on the sale of the item described by item data 113. In this embodiment, the user of seller device 140 specifies, for example by inputting into seller client program 116 via a user interface, whether the social media account characteristics of the user of buyer device 120 must satisfy each of the plurality of restrictions included in restriction 115 or if the social media account characteristics of the user of buyer device 120 only needs to satisfy one or more of the plurality of restrictions included in restriction 115 in order for the social media account characteristics of the user of buyer device 120 to satisfy restriction 115.

In further embodiments, if a further restriction, such as a keyword restriction as described above, is included as part of restriction 115, marketplace program 112 uses software, such as character recognition software, to determine if the social media characteristics of the user of buyer device 120 match one or more of the specified keywords, depending on the specifications input by the user of seller device 140.

If marketplace program 112 determines that the social media account characteristics of the user of buyer device 120 satisfies restriction 115 (decision 206, “YES” branch), marketplace program 112 transmits offer 114 to seller client program 116 via network 130 (step 208). In other embodiments, the user of seller device 140 may give pre-authorization for acceptance of offers that satisfy restriction 115, in which case, marketplace program 112 accepts offer 114 and completes the sale of the item described by item data 113, sending notification to both buyer client program 118 and seller client program 116 via network 130 that the transaction has been completed.

If marketplace program 112 determines that the social media account characteristics of the user of buyer device 120 does not satisfy restriction 115 (decision 206, “NO” branch), marketplace program 112 stores offer 114 in memory (step 210). In the exemplary embodiment, by storing offer 114 in memory, marketplace program 112 neither accepts nor rejects offer 114.

Marketplace program 112 then determines if restriction 115 has been removed by the user of seller device 140 or is expired (decision 212). In the exemplary embodiment, the user of seller device 140 can remove one or more restrictions of restriction 115, or restriction 115 as a whole, by inputting a request to remove restriction 115 into seller client program 116 via a user interface. The request is then transmitted to marketplace program 112 via network 130 and upon reception of the request; marketplace program 112 removes restriction 115 from memory or disassociates restriction 115 from item data 113. In the exemplary embodiment, in this step, marketplace program 112 only determines if restriction 115 as a whole has expired or been removed by the user of seller device 140. Removal or expiration of one or more restrictions of restriction 115 that does not amount to expiration or removal of restriction 115 as a whole is addressed below.

If marketplace program 112 determines that restriction 115 has been removed by the user of seller device 140 or is expired (decision 212, “YES” branch), marketplace program 112 transmits offer 114 to seller client program 116 via network 130 (step 208). As stated above, in other embodiments, the user of seller device 140 may give pre-authorization for acceptance of offers that satisfy restriction 115. In this case, since restriction 115 has been removed, marketplace program 112 accepts offer 114 and completes the sale of the item described by item data 113, sending notification to both buyer client program 118 and seller client program 116 via network 130 that the transaction has been completed.

If marketplace program 112 determines that restriction 115 has not been removed by the user of seller device 140 (decision 212, “NO” branch), marketplace program 112 determines if restriction 115 has been altered or changed by the user of seller device 140 (decision 214). In the exemplary embodiment, the user of seller device 140 can change restriction 115 by inputting a request detailing the changes into seller client program 116 via a user interface. The request is then transmitted to marketplace program 112 via network 130 and upon reception of the request; marketplace program 112 alters restriction 115 accordingly. In addition, in the exemplary embodiment, expiration or removal of one or more restrictions of restriction 115, but not restriction 115 as a whole, by the user of seller device 140 amounts to an alteration or change of restriction 115.

If the marketplace program 112 determines that restriction 115 has not been altered or changed (decision 214, “NO” branch) marketplace program 112 does not transmit offer 114 to seller client program 116 since offer 114 does not satisfy restriction 115, and instead keeps offer 114 in memory.

If marketplace program 112 determines that restriction 115 has been altered or changed (decision 214, “YES” branch), marketplace program 112 determines if the social media account characteristics of the user of buyer device 120 satisfies the altered version of restriction 115 (decision 216). For example, if restriction 115 is altered by the user of seller device 140 to state that the item described by item data 113 is only to be sold to a buyer that is a member of the social network group of the user of seller device 140 and lives in the northeastern United States, marketplace program 112 re-examines the social media account characteristics of the user of buyer device 120 and determines if the user of buyer device 120 is a member of the social network of the user of seller device 140 and lives in the northeastern United States. In addition, if restriction 115 includes a plurality of restrictions, and restriction 115 is altered by expiration or removal of one or more of the plurality of restrictions by the user of seller device 140, marketplace program 112 determines if the social media account characteristics of the user of buyer device 120 satisfies the altered version of restriction 115. In other words, depending on the specifications input by the user of seller device 140, marketplace program 112 determines if the social media account characteristics of the user of buyer device 120 satisfies the remaining restriction(s) of restriction 115 that are not expired or have not been removed or satisfies at least one or more of the remaining restriction(s) of restriction 115 that are not expired or have been removed.

If marketplace program 112 determines that the social media account characteristics of the user of buyer device 120 satisfies the altered restriction 115 (decision 216, “YES” branch), marketplace program 112 transmits offer 114 to seller client program 116 via network 130 (step 208). As discussed above, in other embodiments, the user of seller device 140 may give pre-authorization for acceptance of offers that satisfy restriction 115, in which case, marketplace program 112 accepts offer 114 and completes the sale of the item described by item data 113, sending notification to both buyer client program 118 and seller client program 116 via network 130 that the transaction has been completed.

If marketplace program 112 determines that the social media account characteristics of the user of buyer device 120 does not satisfy the altered restriction 115 (decision 216, “NO” branch), marketplace program 112 does not transmit offer 114 to seller client program 116 since offer 114 does not satisfy the altered restriction 115, and instead keeps offer 114 in memory.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 3 depicts a block diagram of components of server 110, buyer device 120 and seller device 140 in accordance with an illustrative embodiment of the present invention. It should be appreciated that FIG. 3 provides only an illustration of one implementation and does not imply any limitations with regard to the environments in which different embodiments may be implemented. Many modifications to the environment may be made.

Server 110, buyer device 120, social media server 150 and seller device 140 include communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

The programs marketplace program 112, offer 114, restriction 115 and item data 113 in server 110; programs buyer client program 118 in buyer device 120; program social media site 152 in social media server 150 and programs seller client program 116 in seller device 140 are stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links. The programs marketplace program 112, offer 114, restriction 115 and item data 113 in server 110; programs buyer client program 118 in buyer device 120; program social media site 152 in social media server 150 and programs seller client program 116 in seller device 140 may be downloaded to persistent storage 308 through communications unit 312.

I/O interface(s) 314 allows for input and output of data with other devices that may be connected to server 110, buyer device 120 and seller device 140. For example, I/O interface 314 may provide a connection to external devices 320 such as a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention, e.g., the programs marketplace program 112, offer 114, restriction 115 and item data 113 in server 110; programs buyer client program 118 in buyer device 120; program social media site 152 in social media server 150; and programs seller client program 116 in seller device 140, can be stored on such portable computer-readable storage media and can be loaded onto persistent storage 308 via I/O interface(s) 314. I/O interface(s) 314 can also connect to a display 322.

Display 322 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for restricting sale of an item using social media account characteristics, comprising the steps of:
a computer receiving a first restriction on the sale of an item from a seller, wherein the first restriction is based on at least one social media account characteristic;
the computer receiving an offer for purchase of the item from a buyer, wherein the offer includes characteristics of a social media account of the buyer;
the computer determining whether the characteristics of the social media account of the buyer satisfies the first restriction on the sale of the item; and
based on the determination of whether the characteristics of the social media account of the buyer satisfies the first restriction on the sale of the item, the computer determining whether to transmit the offer for purchase of the item to the seller.

2. The method of claim 1, wherein the at least one social media account characteristic comprises of: membership to a social media group, personal information contained in a social media account, location information contained in a social media account, or statements posted on a social media account.

3. The method of claim 1, wherein the first restriction includes one or more keywords, wherein the keywords are related to the item for sale; and wherein the step of the computer determining whether the characteristics of the social media account of the buyer satisfies the first restriction on the sale of the item includes determining whether the characteristics of the social media account of the buyer contains one or more of the keywords.

4. The method of claim 1, further comprising the steps of:
the computer determining the characteristics of the social media account of the buyer satisfies the first restriction on the sale of the item; and
the computer transmitting the offer for purchase of the item to the seller.

5. The method of claim 1, further comprising the steps of:
the computer determining the characteristics of the social media account of the buyer do not satisfy the first restriction on the sale of the item; and
the computer storing the offer for purchase of the item.

6. The method of claim 1, wherein the first restriction on the sale of the item is valid for a certain period of time.

7. The method of claim 1, further comprising the step of the computer receiving input from the seller to replace the first restriction on the sale of the item with a second restriction on the sale of the item, wherein the second restriction is based on at least one social media account characteristic.

8. The method of claim 7, further comprising the steps of:
the computer determining that the characteristics of the social media account of the buyer satisfies the second restriction on the sale of the item; and
the computer transmitting the offer for purchase to the seller.

9. A computer program product for restricting sale of an item using social media account characteristics, the computer program product comprising:
one or more computer-readable storage devices and program instructions stored on at least one of the one or more tangible storage devices, the program instructions comprising:
program instructions to receive a first restriction on the sale of an item from a seller, wherein the first restriction is based on at least one social media account characteristic;
program instructions to receive an offer for purchase of the item from a buyer, wherein the offer includes characteristics of a social media account of the buyer;
program instructions to determine whether the characteristics of the social media account of the buyer satisfies the first restriction on the sale of the item; and
based on the determination of whether the characteristics of the social media account of the buyer satisfies the first restriction on the sale of the item, program instructions to determine whether to transmit the offer for purchase of the item to the seller.

10. The computer program product of claim 9, wherein the at least one social media account characteristic comprises of: membership to a social media group, personal information contained in a social media account, location information contained in a social media account, or statements posted on a social media account.

11. The computer program product of claim 9, further comprising:
program instructions to determine the characteristics of the social media account of the buyer satisfies the first restriction on the sale of the item; and
program instructions to transmit the offer for purchase of the item to the seller.

12. The computer program product of claim 9, further comprising:
program instructions to determine the characteristics of the social media account of the buyer do not satisfy the first restriction on the sale of the item; and
program instructions to store the offer for purchase of the item.

13. The computer program product of claim 9, wherein the first restriction on the sale of the item is valid for a certain period of time.

14. The computer program product of claim 9, further comprising program instructions to receive input from the seller to replace the first restriction on the sale of the item with a second restriction on the sale of the item, wherein the second restriction is based on at least one social media account characteristic.

15. The computer program product of claim 14, further comprising:
program instructions to determine that the characteristics of the social media account of the buyer satisfies the second restriction on the sale of the item; and
program instructions to transmit the offer for purchase to the seller.

16. A computer system for restricting sale of an item using social media account characteristics, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a first restriction on the sale of an item from a seller, wherein the first restriction is based on at least one social media account characteristic;
program instructions to receive an offer for purchase of the item from a buyer, wherein the offer includes characteristics of a social media account of the buyer;
program instructions to determine whether the characteristics of the social media account of the buyer satisfies the first restriction on the sale of the item; and
based on the determination of whether the characteristics of the social media account of the buyer satisfies the first restriction on the sale of the item, program instructions to determine whether to transmit the offer for purchase of the item to the seller.

17. The computer system of claim 16, wherein the at least one social media account characteristic comprises of: membership to a social media group, personal information contained in a social media account, location information contained in a social media account, or statements posted on a social media account.

18. The computer system of claim 16, further comprising:
program instructions to determine the characteristics of the social media account of the buyer satisfies the first restriction on the sale of the item; and
program instructions to transmit the offer for purchase of the item to the seller.

19. The computer system of claim 16, further comprising:
program instructions to determine the characteristics of the social media account of the buyer do not satisfy the first restriction on the sale of the item; and
program instructions to store the offer for purchase of the item.

20. The computer system of claim 16, further comprising:
program instructions to receive input from the seller to replace the first restriction on the sale of the item with a second restriction on the sale of the item, wherein the second restriction is based on at least one social media account characteristic;
program instructions to determine that the characteristics of the social media account of the buyer satisfies the second restriction on the sale of the item; and
program instructions to transmit the offer for purchase to the seller.
